(19) United States
(12) Patent Application Publication
(10) Pub. No.: US 2008/0151209 A1
(43) Pub. Date: Jun. 26, 2008

(54) System and method for printing a pattern

(76) Inventor: Ron Naftali, Shoham (IL)

Correspondence Address: Tarek N. Fahmi;Applied Materials, Inc., Patent Counsel, Santa Clara, CA, 95052, US

(21) Appl. No.: 10/796,938

(22) Filed: Mar. 9, 2004

Related U.S. Application Data
(60) Provisional application No. 60/454,855, filed on Mar. 13, 2003.

(51) Int. Cl. G03B 27/54

(52) U.S. Cl. 355/67

(57) ABSTRACT

A method for recording a pattern includes: (i) determining an illumination scheme in response to the pattern; and (ii) directing, in response to the determination, at least one beam of radiation having a first cross-section towards an saturable absorber such as to allow a portion of said bean to propagate towards a radiation sensitive layer; wherein the portion has a second cross-section that is smaller than the first cross-section.

### RELATED APPLICATIONS

This application claims the benefit of U.S. provisional patent application Ser. No. 60/454,855, filed 13 Mar. 2003, incorporated herein by reference.

### FIELD OF THE INVENTION

The present invention relates to systems and methods for printing patterns and especially systems and methods for utilizing saturable absorbers for printing sub-micron pattern on wafers and masks.

### BACKGROUND OF THE INVENTION

### A. Saturable Absorbers

A material can be regarded as a saturable absorber if his light absorption decreases with increasing light intensity. There are various organic as well as synthetic materials that are used as saturable absorbers within optical systems.

Typically, saturable absorbers are positioned within high-speed lasers and facilitate passive mode-locking. Saturable absorbers are also used to regenerate optical signals, control optical systems and the like. The following patents provide a brief description of the various uses of saturable absorbers: U.S. Pat. No. 6,609,839 of Devaux et al., titled “Device including a saturable absorber for regenerating a wavelength-division multiplex signal”; U.S. Pat. No. 6,571,028 of LoCascio et al., titled “optical switch having a saturable absorber”; U.S. Pat. No. 6,625,192 of Arbel et al., titled “High repetition rate optical pulse generator”; U.S. Pat. No. 6,570,892 of Lin et al., titled “Passively mode-locked fiber lasers”; U.S. Pat. No. 6,546,027 of Khaydarov titled “Laser saturable absorber and passive negative feedback elements, and method of producing energy output therefrom”; and U.S. Pat. No. 6,393,035 of Weingarten et al titled “High-repetition rate passively mode-locked solid-state laser”.

### B. Integrated Circuit Lithography

Integrated circuits are very complex devices that include multiple layers. Each layer may include conductive material, isolating material while other layers may include semi-conductive materials. These various materials are arranged in patterns, usually in accordance with the expected functionality of the integrated circuit. The patterns also reflect the manufacturing process of the integrated circuits.

Integrated circuits are manufactured by complex multi-staged manufacturing processes. During this multi-staged process radiation resistive (usually termed photoresist) material is deposited on a substrate/layer, exposed by a photolithographic process, and developed to produce a pattern that defines some areas to be later etched. After the pattern is etched various materials, such as copper are disposed. The deposition step is usually followed by a polishing step by applying chemical processes and/or a combination of chemical as well as mechanical processes.

The size of integrated circuits continues to shrink and there is a growing need to provide methods and system for improving a resolution of lithography systems and methods.

### SUMMARY OF THE INVENTION

The invention provides a method for recording a pattern, the method includes the stages of: (i) determining an illumination scheme in response to the pattern; and (ii) directing, in response to the determination, at least one beam of radiation having a first cross-section towards an saturable absorber such as to allow a portion of said bean to propagate towards a radiation sensitive layer; wherein the portion has a second cross-section that is smaller than the first cross-section.

The invention provides a system for recording a pattern, the system includes: (i) a controller, for determining an illumination scheme in response to the pattern; and (ii) optics, connected to the controller, for directing, in response to the determination, at least one beam of radiation having a first cross-section towards an saturable absorber such as to allow a portion of said bean to propagate towards a radiation sensitive layer; wherein the portion has a second cross-section that is smaller than the first cross-section.

### BRIEF DESCRIPTION OF THE DRAWINGS

The present invention will be more fully understood from the following detailed description of the embodiments thereof, taken together with the following figures:

FIG. 1 illustrates a surrounding in which a single spot is printed, according to an embodiment of the invention;

FIG. 2 illustrates a lithography system, according to an aspect of the invention; and

FIG. 3 is a flow chart of method for printing a pattern, according to an embodiment of the invention.

### DETAILED DESCRIPTION

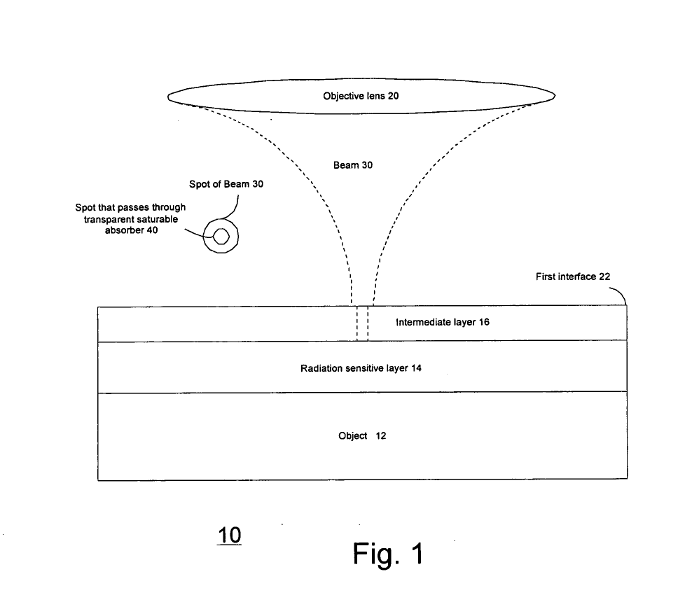

FIG. 1 illustrates a surrounding 10 in which a single spot is printed, according to an embodiment of the invention.

A beam of radiation 30 is focused, by an objective lens 20, substantially onto an intermediate layer 16 that includes saturable absorbers. The intensity of the beam decreases at larger distances from the beam center. Typical beams have an Arie profile or a Gaussian profile, but this is not necessarily so. The intensity of the beam decreases when the distance from the beam center increases. The saturable absorber material of intermediate layer 16 will become transparent at a certain intensity level, that is below the peak intensity level (at the center of the beam, such as a portion of the beam illuminates the radiation sensitive layer 14. The intensity of the beam as well as the properties of the saturable absorbers are adjusted to achieve an required spot size upon the radiation sensitive layer 14.

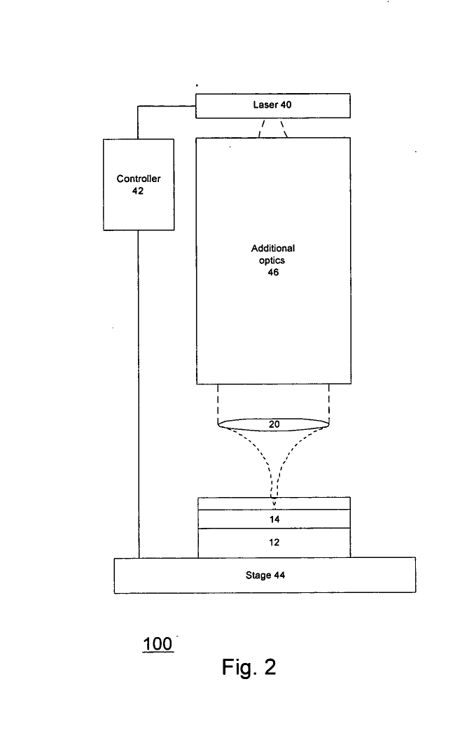

Referring to FIG. 2, illustrating a system 100 that includes a controller 42 as well as optics 43. Optics 43 includes, for example, additional optics 46 as well as a radiation source, such as pento-second laser 40 having a wavelength of few hundred nanometer and even less. Laser 40 is controlled by the controller 42 that is capable of converting a pattern to an illumination scheme. The controller 42 usually co-operates (or controls) with a stage 44 that supports the object 12 and provides a relative translation between the laser and the object. Additional optics 46 is usually positioned between laser 40 and objective lens 20, said additional optics may include collimating optics, polarizing optics and the like. At least a part of said additional optics 46 (for example programmable filters) can be controlled by controller 42.

It is noted that although FIG. 1 illustrates a single beam a typical pattern is usually printed by multiple beams. A lithography process may selectively direct multiple beams towards the intermediate layer simultaneously (for example by using a stepper like lithography scheme, or by selectively scanning the intermediate layer) or may direct only one beam at a time towards the intermediate layer and selectively scan the layer to print the pattern.

Accordingly, the single objective lens 20 may be replaced by an array of lenses or microlenses for increasing the throughput of the lithography system.

Methods for single beam and multiple beam lithography and especially for determining illumination schemes in response to a predefined pattern are known in the art and do not require further explanations. Exemplary multiple beam lithography systems are illustrated at U.S. patent applications 20010331029 and 20010331035 of Almogy. It is noted that scanning patterns should be adapted to the narrower beams that pass through the saturable absorber material.

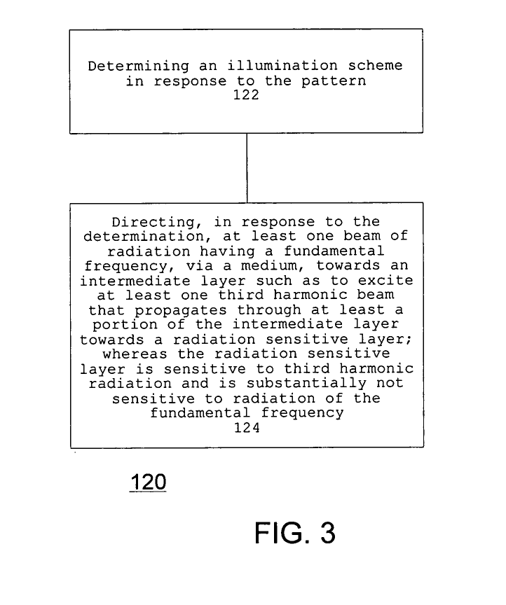

FIG. 3 is a flow chart of method 120 for printing a pattern. Method 120 includes stage 122 of determining an illumination scheme in response to the pattern, and stage 124 of directing, in response to the determination, at least one beam of radiation having a first cross-section towards an saturable absorber such as to allow a portion of said bean to propagate towards a radiation sensitive layer; whereas the portion has a second cross-section that is smaller than the first cross-section.

Conveniently, the intermediate layer should be removed after the pattern is printed.

It should be noted that the particular terms and expressions employed and the particular structural and operational details disclosed in the detailed description and accompanying drawings are for illustrative purposes only and are not intended to in any way limit the scope of the invention as described in the appended claims.

It will thus be appreciated that the preferred embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

What is claimed is:

1. A method for recording a pattern, comprising:
determining an illumination scheme in response to the pattern; and
directing, in response to the determination, at least one beam of radiation having a first cross-section towards an saturable absorber so as to allow a portion of said bean to propagate towards a radiation sensitive layer; wherein the portion has a second cross-section that is smaller than the first cross-section.

2. The method of claim 1 wherein the step of directing comprises focusing at least one beam of radiation onto an intermediate layer.

3. The method of claim 1 wherein the second cross-section is about half of the first cross-section.

4. The method of claim 1 further comprising altering an intensity of the beam of radiation to achieve a certain second cross-section.

5. An system for recording a pattern, comprising:
a controller, for determining an illumination scheme in response to the pattern; and
optics, coupled to the controller, for directing, in response to the determination, at least one beam of radiation having a first cross-section towards a saturable absorber so as to allow a portion of said bean to propagate towards a radiation sensitive layer; wherein the portion has a second cross-section that is smaller than the first cross-section.

6. The system of claim 5 wherein the optics are adapted to focus at least one beam of radiation onto an intermediate layer.

7. The system of claim 5 wherein the second cross-section is about half of the first cross-section.

8. The system of claim 5 wherein the controller is adapted to control an intensity of the beam of radiation to achieve a certain second cross-section.
